(19) United States
(12) Patent Application Publication
(10) Pub. No.: US 2025/0300478 A1
(43) Pub. Date: Sep. 25, 2025

(54) CIRCUIT DEVICE AND ELECTRONIC DEVICE

(71) Applicant: SEIKO EPSON CORPORATION, Tokyo (JP)

(72) Inventors: Masaya Ninomiya, Matsumoto-shi (JP); Yuki Koga, Chino-shi (JP)

(21) Appl. No.: 19/085,570

(22) Filed: Mar. 20, 2025

(30) Foreign Application Priority Data
Mar. 22, 2024 (JP) 2024-045912

(51) Int. Cl. H02J 7/00

(52) U.S. Cl. CPC H02J 7/00714

(57) ABSTRACT

A circuit device includes a current source circuit, a first charging circuit that supplies a first charging current to a charging node, a second charging circuit that supplies a second charging current to the charging node, and a control circuit that sets a current value of the first charging current and the second charging current, based on a current setting value. When the current setting value is in a first range, the first charging circuit supplies the first charging current. When the current setting value is in a second range on a higher current side, the second charging circuit supplies the second charging current. At switching between the first range and the second range, the first charging circuit supplies the first charging current and the second charging circuit supplies the second charging current.

The present application is based on, and claims priority from JP Application Serial Number 2024-045912, filed Mar. 22, 2024, the disclosure of which is hereby incorporated by reference herein in its entirety.

### BACKGROUND

### 1. Technical Field

The present disclosure relates to a circuit device, an electronic device, and the like.

### 2. Related Art

JP-A-10-028338 discloses a charging device that charges a secondary battery from two charging power supplies having different voltages. The voltage of one power supply is slightly lower than a reference voltage applied when charging the secondary battery, and the voltage of the other power supply is higher than the reference voltage. The charging device detects the battery voltage, and charges the battery by the two power supplies when the battery voltage is lower than the voltages of the two power supplies. When the secondary battery is charged to a certain extent and the battery voltage exceeds the voltage of the power supply having a lower voltage, the charging device charges the secondary battery only by the power supply having a higher voltage. In JP-A-10-028338, the charging current decreases as the secondary battery is charged, and the charging ends when the decreased charging current is detected. When the secondary battery is charged to a certain extent, the number of charging power supplies used is switched from two to one, based on the battery voltage, and the detection accuracy of the charging current is thus improved.

JP-A-10-028338 is an example of the related art.

It is assumed that two charging circuits are provided and that a state where the secondary battery is charged by one charging circuit is switched to a state where the secondary battery is charged by the other charging circuit. In this switching, the charging voltage or the charging current may drop momentarily, which may cause trouble in the charging. For example, though the ON resistance of a transistor that controls the charging current supplied to the secondary battery may be low, if the gate width of the transistor is increased in order to reduce the ON resistance, the gate capacitance increases and it takes time for the transistor to switch from OFF to ON, thus generating a state where the secondary battery is not charged from either one of the two charging circuits, and therefore the charging voltage or the charging current may drop momentarily. When the charging voltage or the charging current drops momentarily, for example, the battery protection circuit of the secondary battery may determine that the charging is stopped, based on the drop in the charging current, and thus may stop the charging.

### SUMMARY

According to an aspect of the present disclosure, a circuit device includes: a current source circuit; a first charging circuit that supplies a first charging current of a constant current as a charging current to a charging node, based on a current from the current source circuit; a second charging circuit that supplies a second charging current of a constant current as the charging current to the charging node, based on a current from the current source circuit; and a control circuit that sets a current value of the first charging current and a current value of the second charging current, based on a current setting value for setting a current value of the charging current, wherein the first charging circuit supplies the first charging current to the charging node when the current setting value is in a first range, the second charging circuit supplies the second charging current to the charging node when the current setting value is in a second range on a higher current side than the first range, and the first charging circuit supplies the first charging current to the charging node and the second charging circuit supplying the second charging current to the charging node, at a switching of the current setting value between the first range and the second range.

According to another aspect of the present disclosure, an electronic device includes the above-described circuit device, and a battery coupled to the charging node.

### BRIEF DESCRIPTION OF THE DRAWINGS

FIG. 1 shows a configuration example of a circuit device according to an embodiment and an electronic device including the circuit device.

FIG. 2 shows a detailed configuration example of a first charging circuit and a first current source circuit.

FIG. 3 shows a detailed configuration example of a second charging circuit and a second current source circuit.

FIG. 4 shows an example of parameters of the current source circuits, the first charging circuit, and the second charging circuit.

FIG. 5 illustrates a problem in the case of charging in which the first charging circuit and the second charging circuit are simply switched without using the method according to the embodiment.

FIG. 6 illustrates a problem in the case of charging in which the first charging circuit and the second charging circuit are simply switched without using the method according to the embodiment.

FIG. 7 shows a first example of charging switching control according to the embodiment.

FIG. 8 shows a second example of the charging switching control according to the embodiment.

FIG. 9 shows a third example of the charging switching control according to the embodiment.

FIG. 10 shows a fourth example of the charging switching control according to the embodiment.

FIG. 11 shows a fifth example of the charging switching control according to the embodiment.

FIG. 12 shows a sixth example of the charging switching control according to the embodiment.

### DESCRIPTION OF EMBODIMENTS

A preferred embodiment of the disclosure will be described in detail below. The embodiment described below does not unduly limit the content described in the claims, and not all of the elements described in the embodiment are necessarily essential elements.

### 1. Circuit Device and Electronic Device

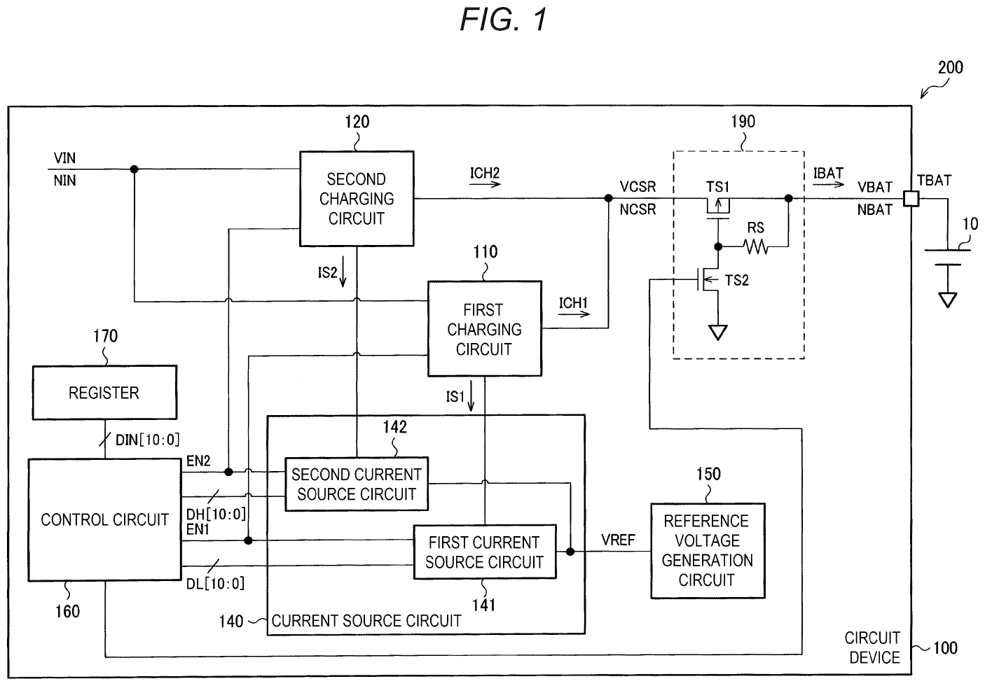

FIG. 1 shows a configuration example of a circuit device according to the present embodiment and an electronic device including the circuit device.

An electronic device 200 includes a circuit device 100 and a battery 10. The battery 10 is a secondary battery, for example, a lithium ion secondary battery, a nickel-hydrogen rechargeable battery, a nickel-cadmium rechargeable battery, or the like. The electronic device 200 may be a device having the battery 10 built therein or a device to which the battery 10 can be attached. As an example, the electronic device 200 is a smartphone, a tablet terminal, a wireless earphone, a wireless hearing aid, a smart watch, a digital camera, a mobile battery, or the like. When the electronic device 200 is a smartphone or the like, the electronic device 200 may include a processing device, a storage device, a wireless communication device, a display device, an operation input device, or the like.

The circuit device 100 charges the battery 10, based on power supplied from outside. The circuit device 100 includes a first charging circuit 110, a second charging circuit 120, a current source circuit 140, a reference voltage generation circuit 150, a control circuit 160, a register 170, a reverse current blocking circuit 190, and a terminal TBAT. The circuit device 100 is, for example, an integrated circuit device in which a plurality of circuit elements are integrated at a semiconductor substrate.

The reverse current blocking circuit 190 is provided between an output node NCSR of the first charging circuit 110 and the second charging circuit 120, and a charging node NBAT coupled to the terminal TBAT. A terminal of the battery 10 is coupled to the terminal TBAT. When the control circuit 160 turns on the reverse current blocking circuit 190, a first charging current ICH1 from the first charging circuit 110, a second charging current ICH2 from the second charging circuit 120, or the first charging current ICH1 and the second charging current ICH2 are supplied as a charging current IBAT to the charging node NBAT. When the charging current IBAT is supplied from the terminal TBAT to the battery 10, the battery 10 is charged.

The reverse current blocking circuit 190 includes a P-type transistor TS1, an N-type transistor TS2, and a resistor RS. The source of the P-type transistor TS1 is coupled to the charging node NBAT, and the drain thereof is coupled to the output node NCSR. The source of the N-type transistor TS2 is coupled to a ground node, and the drain thereof is coupled to the gate of the P-type transistor TS1. One end of the resistor RS is coupled to the charging node NBAT, and the other end is coupled to the gate of the P-type transistor TS1. When the control circuit 160 turns off the N-type transistor TS2, the P-type transistor TS1 is turned off. The P-type transistor TS1 includes a parasitic diode whose forward direction is the direction from the output node NCSR to the charging node NBAT, and therefore when the P-type transistor TS1 is off, the reverse current blocking circuit 190 blocks a reverse current from the battery 10 to the first charging circuit 110 and the second charging circuit 120. When charging the battery 10, the control circuit 160 turns on the N-type transistor TS2. Thus, the P-type transistor TS1 is turned on. In the description below, the charging operation when the P-type transistor TS1 of the reverse current blocking circuit 190 is on will be mainly described.

The reference voltage generation circuit 150 generates a reference voltage VREF. The reference voltage generation circuit 150 is, for example, a bandgap reference circuit, but is not limited to this. The reference voltage VREF may be supplied from outside the circuit device 100.

Register 170 stores a current setting value DIN[10:0]. In this example, the current setting value is 11-bit data, but any number of bits may be used. For example, a processor or the like, which is an external host device, writes the current setting value DIN[10:0] to the register 170 via an interface circuit, not illustrated. The host device, for example, sets the current value of the charging current IBAT, based on a detection result from a detection circuit, not illustrated, that detects a battery voltage VBAT. Instead of the host device, the circuit device 100 may include a detection circuit, not illustrated, that detects the battery voltage VBAT, and a circuit that sets the current value of the charging current IBAT, based on the detection result.

The control circuit 160 controls the current source circuit 140, the first charging circuit 110, and the second charging circuit 120 so that the charging current IBAT set by the current setting value DIN[10:0] is supplied to the battery 10. The control circuit 160 outputs a first enable signal EN1, a first current source control value DL[10:0], a second enable signal EN2, and a second current source control value DH[10:0], based on the current setting value DIN[10:0]. Thus, the control circuit 160 switches between charging by the first charging circuit 110, charging by the second charging circuit 120, and charging by the first charging circuit 110 and the second charging circuit 120, according to the current value indicated by the current setting value DIN[10:0]. In this example, the number of bits of the first current source control value and the second current source control value is 11 bits, which is the same as the number of bits of the current setting value, but the number of bits of the first current source control value and the second current source control value may be any number and may be different from the number of bits of the current setting value.

The current source circuit 140 includes a first current source circuit 141 and a second current source circuit 142. When the first enable signal EN1 is in an enable state, the first current source circuit 141 generates a first current IS1 set by the first current source control value DL[10:0], based on the reference voltage VREF, and supplies the first current IS1 to the first charging circuit 110. When the second enable signal EN2 is in an enable state, the second current source circuit 142 generates a second current IS2 set by the second current source control value DH[10:0], based on the reference voltage VREF, and supplies the second current IS2 to the second charging circuit 120.

A power supply voltage VIN is supplied to a power supply node NIN. The power supply voltage VIN is supplied from, for example, an external power supply of the circuit device 100. Alternatively, the circuit device 100 may include a power receiving circuit, a voltage conversion circuit, or the like, not illustrated, that receives power from an external power supply and outputs the power supply voltage VIN.

When the first enable signal EN1 is in the enable state, the first charging circuit 110 amplifies the first current IS1 at a first amplification ratio, and supplies the amplified current as the first charging current ICH1 from the power supply node NIN to the output node NCSR. The first charging current ICH1 is output as the charging current IBAT to the charging node NBAT.

When the second enable signal EN2 is in the enable state, the second charging circuit 120 amplifies the second current IS2 at the second amplification ratio, and supplies the amplified current as the second charging current ICH2 from the power supply node NIN to the output node NCSR. The second charging current ICH2 is output as the charging current IBAT to the charging node NBAT. The second amplification ratio is higher than the first amplification ratio.

Basically, in a first range where the current setting value DIN[10:0] indicates a low current, the first charging circuit 110 outputs the first charging current ICH1 as the charging current IBAT, and in a second range where the current setting value DIN[10:0] indicates a high current, the second charging circuit 120 outputs the second charging current ICH2 as the charging current IBAT. The current value of the second charging current ICH2 is basically higher than the current value of the first charging current ICH1. In the present embodiment, in a switching range between the first range and the second range, the first charging circuit 110 outputs the first charging current ICH1 and the second charging circuit 120 outputs the second charging current ICH2. At this time, the sum value of the first charging current ICH1 and the second charging current ICH2 is output as the charging current IBAT. Thus, trouble in charging due to the charging current IBAT being zero can be prevented. In the switching range or the like, the current value of the second charging current ICH2 may be lower than the current value of the first charging current ICH1. Details of the charging control according to the present embodiment will be described later.

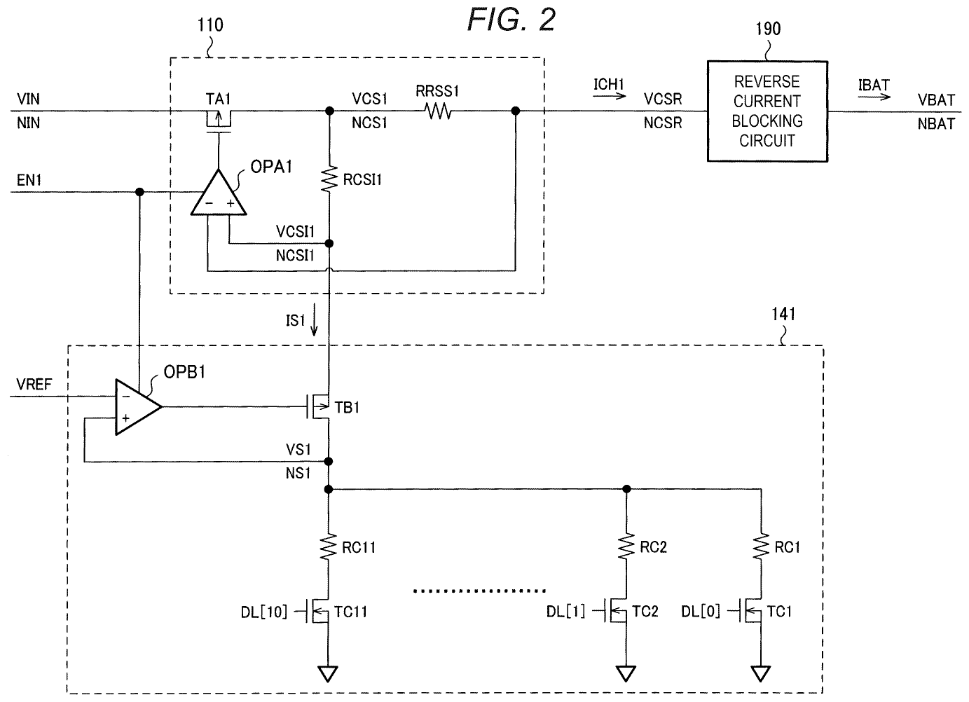

FIG. 2 shows a detailed configuration example of the first charging circuit and the first current source circuit. The first charging circuit 110 includes an operational amplifier OPA1, a P-type transistor TA1, a resistor RCSI1, and a resistor RRSS1.

The source of the P-type transistor TA1 is coupled to the power supply node NIN, and the drain thereof is coupled to a node NCS1. The power supply voltage VIN is supplied to the power supply node NIN. One end of the resistor RCSI1 is coupled to the node NCS1, and the other end thereof is coupled to a node NCSI1. One end of the resistor RRSS1 is coupled to the node NCS1, and the other end thereof is coupled to the output node NCSR. The non-inverting input terminal of the amplifier circuit OPAL is coupled to the node NCSI1, the inverting input terminal thereof is coupled to the output-node NCSR, and the output node thereof is coupled to the gate of the P-type transistor TA1.

When the first enable signal EN1 is in the enable state, the operational amplifier OPA1 enters an operation-enabled state. Thus, the first charging current ICH1=(RCSI1/RRSS1)×IS1 is supplied to the output node NCSR, and is supplied as the charging current IBAT to the charging node NBAT.

The first current source circuit 141 includes an operational amplifier OPB1, a P-type transistor TB1, resistors RC1 to RC11, and N-type transistors TC1 to TC11.

The source of the P-type transistor TB1 is coupled to the node NCSI1, and the drain thereof is coupled to a node NS1. The reference voltage VREF is input to the inverting input terminal of the operational amplifier OPB1. The non-inverting input terminal of the operational amplifier OPB1 is coupled to the node NS1, and the output node thereof is coupled to the gate of the P-type transistor TB1. One end of the resistor RC1 is coupled to the node NS1, and the other end is coupled to the drain of the N-type transistor TC1. The source of the N-type transistor TC1 is coupled to a ground node. Similarly, one end of the resistors RC2 to RC11 is coupled to the node NS1, and the other end is coupled to the drains of the N-type transistors TC2 to TC11. The sources of the N-type transistors TC2 to TC11 are coupled to the ground node. The first bit signal DL[0] of the first current source control value DL[10:0] is input to the gate of the N-type transistor TC1. Similarly, the second to eleventh bit signals DL[1] to DL[10] of the first current source control value DL[10:0] are input to the gates of the N-type transistors TC2 to TC11.

When the first enable signal EN1 is in the enable state, the operational amplifier OPB1 is in an operation-enabled state. Thus, the voltage at the node NS1 is VS1=VREF. The resistor RC1 and the N-type transistor TC1 are referred to as a first current source of the first current source circuit 141. When the first bit signal DL[0] is 1, the N-type transistor TC1 is on and the first current source supplies a current of VREF/RC1. Similarly, the resistors RC2 to RC11 and the N-type transistors TC2 to TC11 are referred to as second to eleventh current sources of the first current source circuit 141. When the second to eleventh bit signals DL[1] to DL[10] are 1, the N-type transistors TC2 to TC11 are on and the second to eleventh current sources supply currents of VREF/RC2 to VREF/RC11. The first current IS1 flowing through the P-type transistor TB1 is the sum of the currents supplied from the current source(s) corresponding to the bit signal of one, of the bit signals of the first current source control value DL[10:0].

When the first enable signal EN1 is in a disable state, the operational amplifiers OPA1 and OPB1 are in an operation-disabled state. At this time, the P-type transistors TA1 and TB1 are off and the first current IS1 and the first charging current ICH1 do not flow.

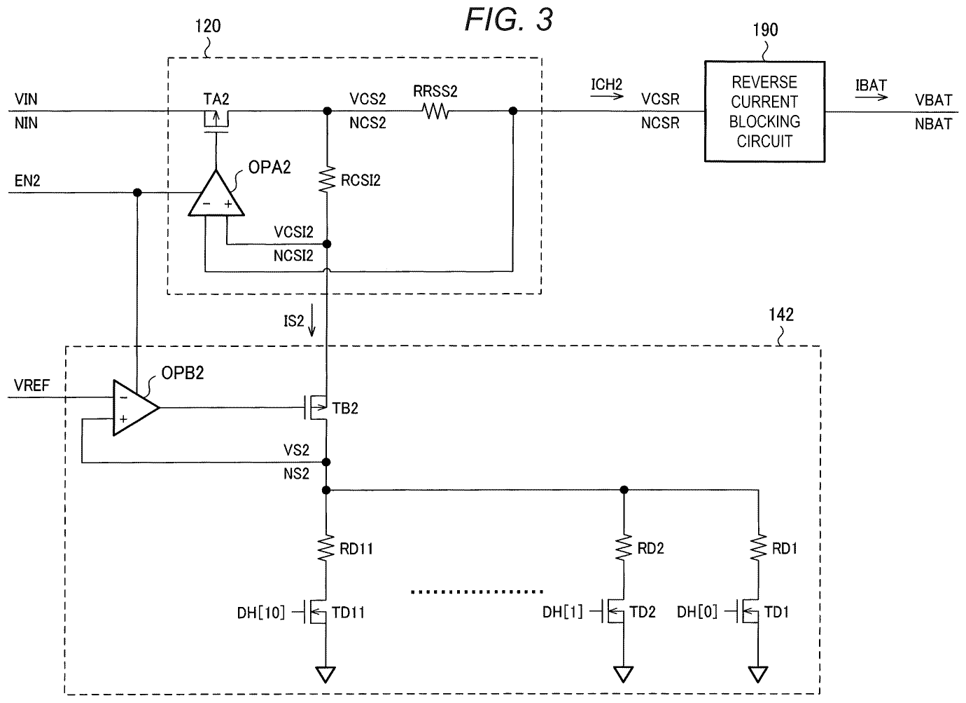

FIG. 3 is a detailed configuration example of the second charging circuit and the second current source circuit. The second charging circuit 120 includes an operational amplifier OPA2, a P-type transistor TA2, resistor RCSI2, and a resistor RRSS2.

The source of the P-type transistor TA2 is coupled to the power supply node NIN, and the drain thereof is coupled to a node NCS2. One end of the resistor RCSI2 is coupled to the node NCS2, and the other end thereof is coupled to a node NCSI2. One end of the resistor RRSS2 is coupled to the node NCS2, and the other end thereof is coupled to the output node NCSR. The non-inverting input terminal of the amplifier circuit OPA2 is coupled to the node NCSI2, the inverting input terminal thereof is coupled to the output node NCSR, and the output node thereof is coupled to the gate of the P-type transistor TA2.

When the second enable signal EN2 is in the enable state, the operational amplifier OPA2 enters an operation-enabled state. Thus, the second charging current ICH2=(RCSI2/RRSS2)×IS2 is supplied to the output node NCSR, and is supplied as the charging current IBAT to the charging node NBAT.

The second current source circuit 142 includes an operational amplifier OPB2, a P-type transistor TB2, resistors RD1 to RD11, and N-type transistors TD1 to TD11.

The source of the P-type transistor TB2 is coupled to the node NCSI2, and the drain thereof is coupled to a node NS2. The reference voltage VREF is input to the inverting input terminal of the operational amplifier OPB2. The non-inverting input terminal of the operational amplifier OPB2 is coupled to the node NS2, and the output node thereof is coupled to the gate of the P-type transistor TB2. One end of the resistor RD1 is coupled to the node NS2, and the other end is coupled to the drain of the N-type transistor TD1. The source of the N-type transistor TD1 is coupled to a ground node. Similarly, one end of the resistors RD2 to RD11 is coupled to the node NS2, and the other end is coupled to the drains of the N-type transistors TD2 to TD11. The sources of the N-type transistors TD2 to TD11 are coupled to the ground node. The first bit signal DH[0] of the second current source control value DH[10:0] is input to the gate of the N-type transistor TD1. Similarly, the second to eleventh bit signals DH[1] to DH[10] of the second current source control value DH[10:0] are input to the gates of the N-type transistors TD2 to TD11.

When the second enable signal EN2 is in the enable state, the operational amplifier OPB2 is in an operation-enabled state. Thus, the voltage at the node NS2 is VS2=VREF. The resistor RD1 and the N-type transistor TD1 are referred to as a first current source of the second current source circuit 142. When the first bit signal DH[0] is 1, the N-type transistor TD1 is on and the first current source supplies a current of VREF/RD1. Similarly, the resistors RD2 to RD11 and the N-type transistors TD2 to TD11 are referred to as second to eleventh current sources of the second current source circuit 142. When the second to eleventh bit signals DH[1] to DH[10] are 1, the N-type transistors TD2 to TD11 are on and the second to eleventh current sources supply currents of VREF/RD2 to VREF/RD11. The second current IS2 flowing through the P-type transistor TB2 is the sum of the currents supplied from the current source(s) corresponding to the bit signal of one, of the bit signals of the second current source control value DH[10:0].

When the second enable signal EN2 is in a disable state, the operational amplifiers OPA2 and OPB2 are in an operation-disabled state. At this time, the P-type transistors TA2 and TB2 are off and the second current IS2 and the second charging current ICH2 do not flow.

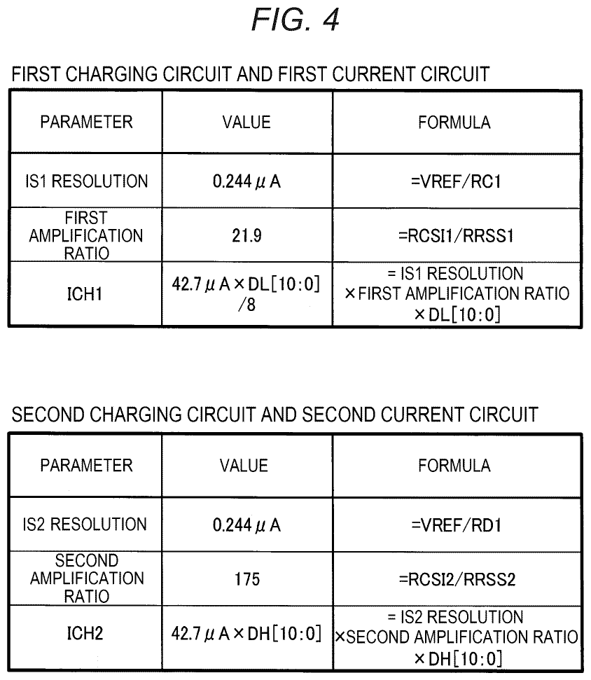

FIG. 4 shows an example of parameters of the current source circuits, the first charging circuit, and the second charging circuit. The parameters are not limited to those shown in FIG. 4. The parameters illustrated in FIG. 4 are ideal values that are set without taking manufacturing variations and the like into account, and in practice, the parameters may have an error due to manufacturing variations or the like.

As shown in the top diagram, the resolution of the first current IS1, that is, the current flowing through the resistor RC1 when the N-type transistor TC1 is turned on in the first current source circuit 141, is VREF/RC1. In this example, it is assumed that VREF/RC1=0.244 μA. The resistance ratio of the resistors RC1 to RC11 is weighted in binary. That is, the RC11:RC10: . . . :PC1=1:2: . . . :1024. The first current IS1 linearly changes at the step of 0.244 μA in accordance with the first current source control value DL[10:0].

The first charging circuit 110 amplifies the first current IS1 with the first amplification ratio RCSI1/RRSS1. In this example, it is assumed that RCSI1/RRSS1=21.9. The first charging current is ICH1=IS1 resolution×first amplification ratio×DL[10:0]=42.7 μA×DL[10:0]/8. The control circuit 160 shifts the current setting value DIN[10:0] to the upper side by three bits and thus sets the current setting value DIN[10:0] to be the first current source control value DL[10:0]. That is, DL[10:0]/8=DIN[10:0], and the step of the first charging current ICH1 with respect to the LSB of the current setting value DIN[10:0] is 42.7 μA. In principle, DL[10:0]/8=DIN[10:0] holds, but this does not always hold. A detailed example will be described later.

As shown in the bottom diagram, the resolution of the second current IS2, that is, the current flowing through the resistor RD1 when the N-type transistor TD1 is turned on in the second current source circuit 142, is VREF/RD1. In this example, it is assumed that VREF/RD1=VREF/RC1=0.244 μA. The resistance ratio of the resistors RD1 to RD11 is weighted in binary. That is, RD11:RD10: . . . :RD1=1:2: . . . :1024. The second current IS2 linearly changes at the step of 0.244 μA in accordance with the second current source control value DH[10:0].

The second charging circuit 120 amplifies the second current IS2 with the second amplification ratio RCSI2/RRSS2. In this example, it is assumed that RCSI2/RRSS2=(RCSI1/RRSS1)×8=175. The second charging current is ICH2=IS2 resolution×second amplification ratio ×DH[10:0]=42.7 μA×DH[10:0]. The control circuit 160 sets the current setting value DIN[10:0] to be the second current source control value DH[10:0] without bit shifting. That is, DH[10:0]=DIN[10:0], and the step of the second charging current ICH2 with respect to the LSB of the current setting value DIN[10:0] is 42.7 μA. In principle, DH[10:0]=DIN[10:0] holds, but this does not always hold. A detailed example will be described later.

As described above, both the first charging current ICH1 and the second charging current ICH2 change at the step of 42.7 μA with respect to the LSB of the current setting value DIN[10:0]. That is, the charging current IBAT linearly changes at the step of 42.7 μA with respect to the LSB of the current setting value DIN[10:0].

An example in which the control circuit 160 multiplies the current setting value DIN[10:0] by eight and thus sets the current setting value DIN[10:0] to be first current source control value DL[10:0] is described, but this is not limiting. The control circuit 160 may multiply the current setting value DIN[10:0] by r and thus set the current setting value DIN[10:0] to be the first current source control value DL[10:0]. The number r is a real number larger than 1. Thus, the steps of the first charging current ICH1 and the second charging current ICH2 with respect to the LSB of the current setting value DIN[10:0] are the same.

### 2. Method of Switching Between First Charging Circuit and Second Charging Circuit

A method of switching between the charging by the first charging circuit 110 and the charging by the second charging circuit 120 will now be described. It is assumed that the high level of the first enable signal EN1 and the second enable signal EN2 indicates the enable state, and that the low level indicates the disable state. However, the low level may correspond to the enable state, and the high level may correspond to the disable state. In the description below, an example in which the boundary of switching is set at DIN[10:0]=256 will be described, but the boundary of switching may be any point. In the description below, an example in which the current setting value DIN[10:0] is increased will be described, but when the current setting value DIN[10:0] is to be decreased, the control described below may be executed in the reverse order.

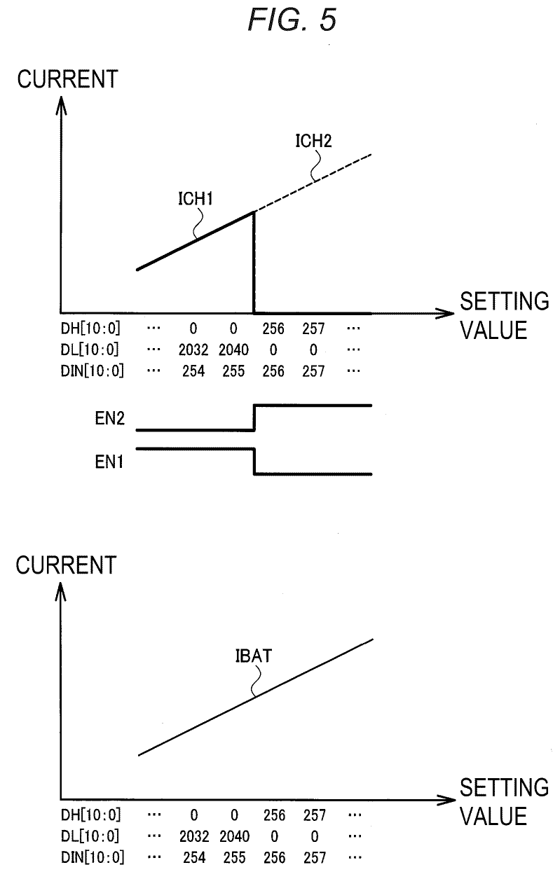

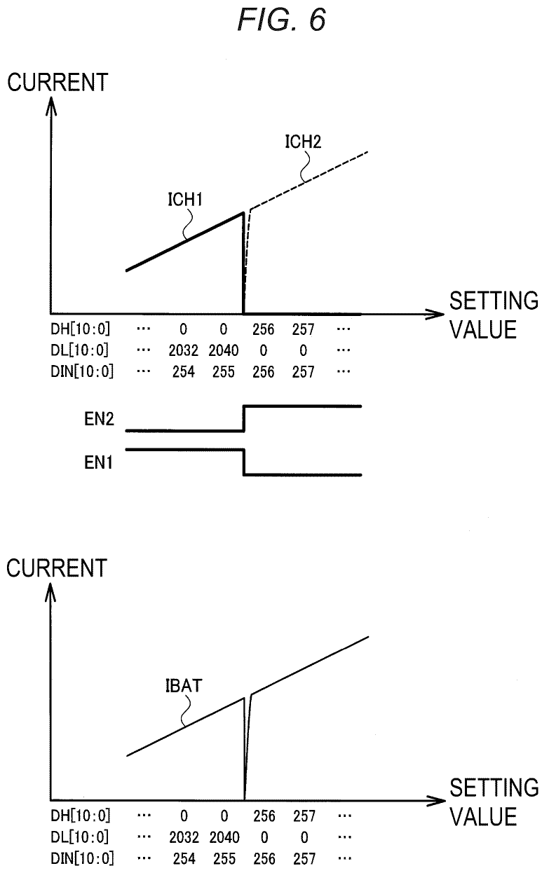

First, a problem in the case of charging in which the first charging circuit and the second charging circuit simply switched without using the method according to the present embodiment, described later, will be described with reference to FIGS. 5 and 6. In the description below, the current setting value DIN[10:0] is incremented at constant intervals, but the way the current setting value DIN[10:0] is changed is not limited to this.

As illustrated in the top diagram in FIG. 5, when the current setting value DIN[10:0] is equal to or greater than 0 and equal to or less than 255, the control circuit 160 outputs the first enable signal EN1 in the enable state, the second enable signal EN2 in the disable state, the first current source control value DL[10:0]=8×DIN[10:0], and the second current source control value DH[10:0]=0. The expression “×8” represents a 3-bit shift to the upper side. As shown in the bottom diagram, the charging current supplied to the battery 10 is IBAT=ICH1.

As shown in the top diagram, when the current setting value DIN[10:0] is equal to or greater than 256 and equal to or less than 2047, the control circuit 160 outputs the first enable signal EN1 in the disable state, the second enable signal EN2 in the enable state, the first current source control value DL[10:0]=0, and the second current source control value DH[10:0]=DIN[10:0]. As shown in the bottom diagram, the charging current supplied to the battery 10 is IBAT=ICH 2.

When the current setting value DIN[10:0] is to be incremented at constant intervals, the horizontal axis of the graph can be regarded as a time axis. FIG. 5 shows a case where the second charging current ICH2 is instantaneously output when the second enable signal EN2 is switched from the disable state to the enable state. In this case, as shown in the bottom diagram in FIG. 5, when the current setting value DIN[10:0] is switched from 255 to 256, IBAT=ICH1 or IBAT=ICH2 is output without exception, and therefore a drop or the like in the charging current IBAT supplied to the battery 10 does not occur.

FIG. 6 shows a case where a delay occurs at the start of the output of the second charging current ICH2 when the second enable signal EN2 is switched from the disable state to the enable state. In order to output the second charging current ICH2 for high charging, the gate width of the P-type transistor TA2 in FIG. 3 needs to be increased to lower the resistance value. Thus, the gate capacitance of the P-type transistor TA2 increases, and therefore a delay occurs until the operational amplifier OPA2 drives and turns on the gate of the P-type transistor TA2 after the second enable signal EN2 is switched to the enable state.

As shown in the top diagram, when the horizontal axis of the graph is regarded as the time axis, the rise of the second charging current ICH2 is slow due to the delay. Therefore, as shown in the bottom diagram, when the current setting value DIN[10:0] is switched from 255 to 256, there is a delay until the rise of IBAT=ICH2 after IBAT=ICH1 becomes zero, and the charging current IBAT supplied to the battery 10 drops. Due to the drop in the charging current IBAT, trouble may occur in the charging of the battery 10. For example, the battery protection circuit of the secondary battery may determine that the charging is stopped, based on the drop in the charging current IBAT, and thus may stop the charging.

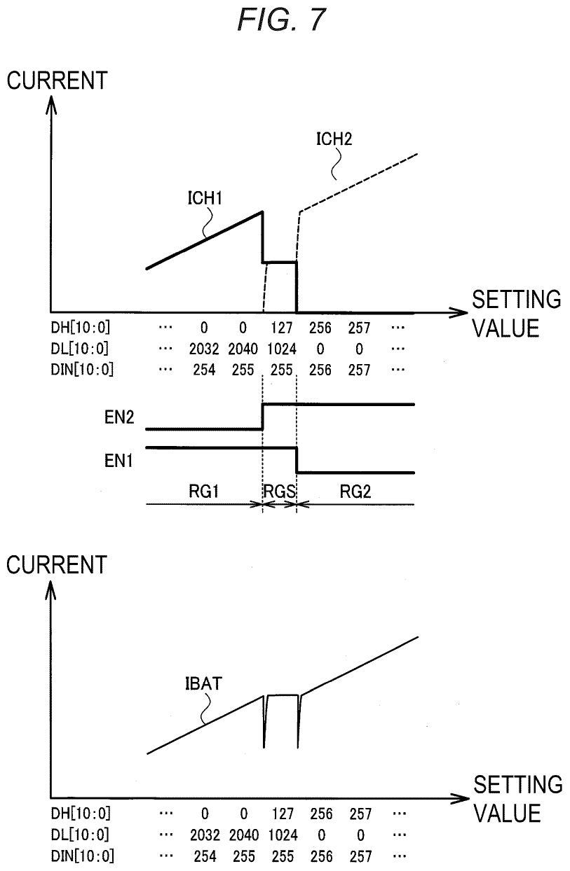

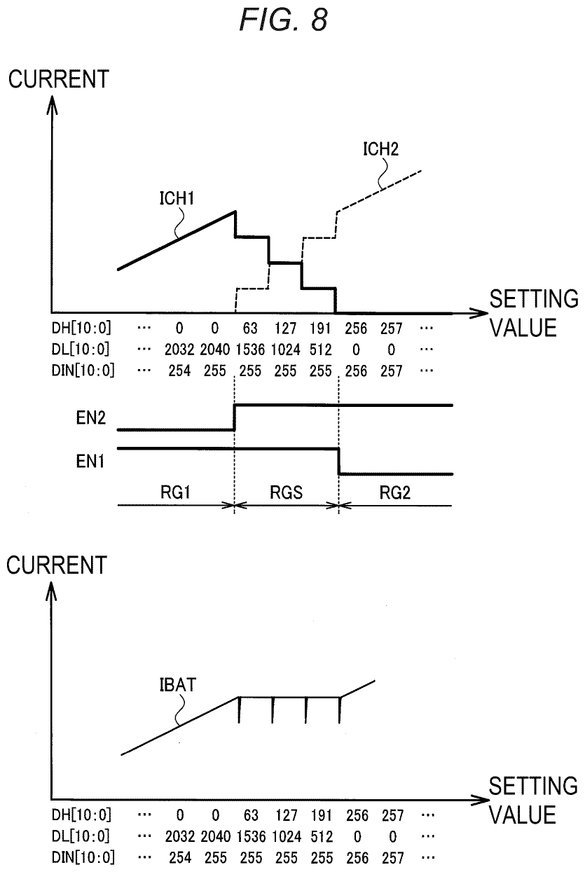

FIG. 7 shows a first example of charging switching control according to the present embodiment. A range of 0 or more and 254 or less and the first 255, of the current setting value DIN[10:0], is defined as a first range RG1, a range of the second and subsequent 255 is defined as a switching range RGS, and a range of 256 or more and 2047 or less is defined as a second range RG2. In this example, the switching range RGS is referred to as a “range”, but this part may be regarded as a “switching” between the first range RG1 and the second range RG2 instead of a range. That is, the first range RG1 is 0 or more and up to 255 and the second range RG2 is 256 or more and 2047 or less, and in the description below, the control in the “switching” between these ranges is described as the control in the switching range RGS. This also applies to FIGS. 8 to 10.

As shown in the top diagram, in the first range RG1, the control circuit 160 outputs the first enable signal EN1 in the enable state, the second enable signal EN2 in the disable state, the first current source control value DL[10:0]=8×DIN[10:0], and the second current source control value DH[10:0]=0. In the second range RG2, the control circuit 160 outputs the first enable signal EN1 in the disable state, the second enable signal EN2 in the enable state, the first current source control value DL[10:0]=0, and the second current source control value DH[10:0]=DIN[10:0]. Immediately after the current setting value DIN[10:0] changes from 254 to 255, the control circuit 160 outputs EN1=enable, EN2=disable, DL[10:0]=8×255=2040, and DH[10:0]=0. In this example, this state is included in the first range RG1.

In the switching range RGS after the current setting value DIN[10:0] changes from 254 to 255, the control circuit 160 outputs EN1=EN2=enable, DL[10:0]=8×256×(½)=1024, and DH[10:0]=255×(½)≈127. The state of EN1=EN2=enable may be implemented when a predetermined time passes after DIN[10:0] changes from 254 to 255, or may be implemented at a predetermined time immediately before DIN[10:0] switches from 255 to 256. Alternatively, EN1=EN2=enable, DH[10:0]=127, and DL[10:0]=1024 may be implemented immediately after DIN[10:0] changes from 254 to 255. That is, in FIG. 7, the state of DH[10:0]=0 and DL[10:0]=2040 corresponding to the first 255 of DIN[10:0] may be absent. In this case, the first range RG1 is a range of 0 or more and 254 or less, the switching range RGS is DIN[10:0]=255, and the second range RG2 is a range of 256 or more and 2047 or less.

As shown in the top diagram and the bottom diagram, when EN1=EN2=enable, the first current source control value DL[10:0] and the second current source control value DH[10:0] are set in such a way that the sum of the first charging current ICH1 and the second charging current ICH2 is the charging current IBAT corresponding to the current setting value DIN[10:0]=255. In the example of FIG. 7, the first and second current source control values are set in such a way as to achieve ICH1=ICH2=IBAT×(½). Thus, the change in the second charging current ICH2 is IBAT×(½) at the maximum, and therefore the drop in the charging current IBAT is up to ½ even when a delay occurs. As both the first charging circuit 110 and the second charging circuit 120 are enabled in the switching range RGS in this way, the drop in the charging current IBAT can be reduced and the likelihood of the occurrence of the charging failure of the battery 10 can be reduced.

The switching range RGS may not be one value but may be a plurality of values. For example, DIN[10:0]=255, 256 may be the switching range RGS, and DIN[10:0]≥257 may be the second range RG2. For example, the control in the first range RG1 and the second range RG2 and for DIN[10:0]=255 is as described above, and when DIN[10:0]=256, the control circuit 160 outputs EN1=EN2=enable, DL[10:0]=8×256×(½)=1024, and DH[10:0]=256×(½)=128.

FIG. 8 shows a second example of the charging switching control according to the present embodiment. The definitions of the first range RG1, the second range RG2, and the switching range RGS are the same as in the first example. The control in the first range RG1 and the second range RG2 is the same as in the first example.

In the switching range RGS after the current setting value DIN[10:0] changes from 254 to 255, the control circuit 160 outputs EN1=enable, EN2=disable, DL[10:0]=8×255=2040, and DH[10:0]=0. Subsequently, the control circuit 160 outputs EN1=EN2=enable. At this time, the control circuit 160 outputs DL[10:0]=8×256×(¾)=1536 and DH[10:0]=255×(¼)≈63. Next, the control circuit 160 outputs DL[10:0]=8×256×( 2/4)=1024 and DH[10:0]=255×( 2/4)≈127. Next, the control circuit 160 outputs DL[10:0]=8×256×(¼)=512 and DH[10:0]=255×(¾)≈191.

In the second example, in the switching range RGS, the change of the second charging current ICH2 becomes IBAT×(¼) at the maximum, and therefore the drop in the charging current IBAT is up to ¼ even when a delay occurs. Alternatively, EN1=EN2=enable, DH[10:0]=63, and DL[10:0]=1536 may be implemented immediately after DIN[10:0] changes from 254 to 255. That is, in FIG. 8, the state of DH[10:0]=0 and DL[10:0]=2040 corresponding to the first 255 of DIN[10:0] may be absent.

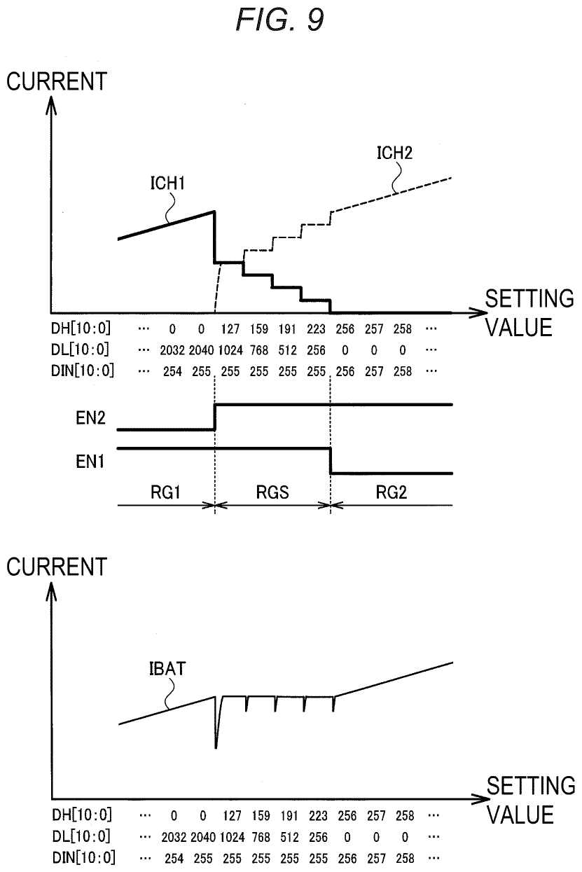

FIG. 9 shows a third example of the charging switching control according to the present embodiment. The definitions of the first range RG1, the second range RG2, and the switching range RGS are the same as in the first example. The control in the first range RG1 and the second range RG2 is the same as in the first example.

In the switching range RGS after the current setting value DIN[10:0] changes from 254 to 255, the control circuit 160 outputs EN1=EN2=enable. At this time, the control circuit 160 outputs DL[10:0]=8×256×(½)=1024 and DH[10:0]=255×(½)≈127. Next, the control circuit 160 outputs DL[10:0]=8×256×(⅜)=768 and DH[10:0]=255×(⅝)≈159. Next, the control circuit 160 outputs DL[10:0]=8×256×( 2/8)=512 and DH[10:0]=255×( 6/8)≈191. Next, the control circuit 160 outputs DL[10:0]=8×256×(⅛)=256 and DH[10:0]=255×(⅞)≈223.

In the third example, in the switching range RGS, the change of the second charging current ICH2 becomes IBAT×(½) at the maximum, and therefore the drop in the charging current IBAT is up to ½ even when a delay occurs. Although a drop by half occurs twice in the first example, such a drop occurs only once in the third example. The second drop is dispersed to four drops, each by one-eighth. Also, EN1=EN2=enable, DH[10:0]=127, and DL[10:0]=1024 may be implemented immediately after DIN[10:0] changes from 254 to 255. That is, in FIG. 9, the state of DH[10:0]=0 and DL[10:0]=2040 corresponding to the first 255 of DIN[10:0] may be absent.

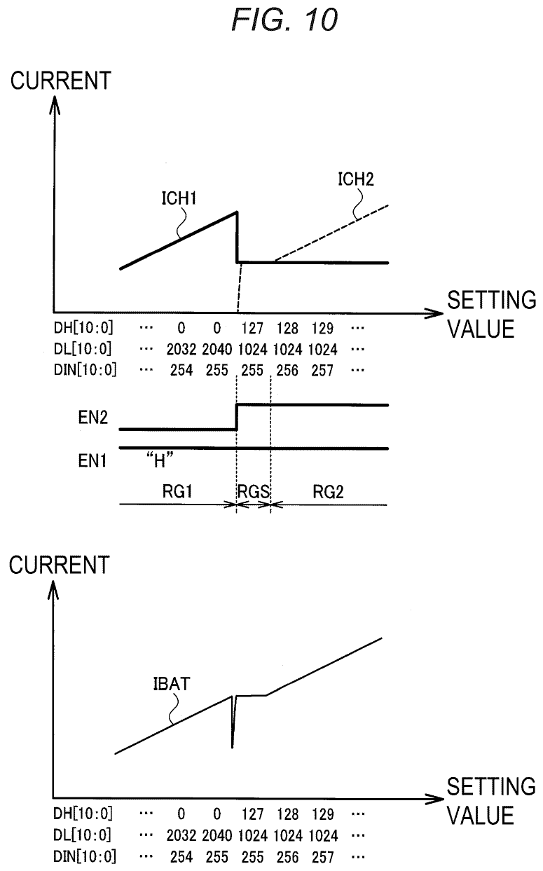

FIG. 10 shows a fourth example of the charging switching control according to the present embodiment. The definitions of the first range RG1, the second range RG2, and the switching range RGS are the same as in the first example. The control in the first range RG1 is the same as in the first example.

In the switching range RGS after the current setting value DIN[10:0] changes from 254 to 255, the control circuit 160 outputs EN1=EN2=enable, DL[10:0]=8×256×(½)=1024, and DH[10:0]=255×(½)≈127.

In the fourth example, in the second range RG2, the control circuit 160 maintains EN1=EN2=enable and DL[10:0]=8×256×(½)=1024. The control circuit 160 outputs DH[10:0]=DIN[10:0]−256×(½). Since the second charging current ICH2 equivalent to “−256×(½)” of DH[10:0] is compensated for by the first charging current ICH1 based on DL[10:0], the overall charging current IBAT has a current value corresponding to the current setting value DIN[10:0].

In the fourth example, in the switching range RGS, the change of the second charging current ICH2 becomes IBAT×(½) at the maximum, and therefore the drop in the charging current IBAT is up to ½ even when a delay occurs. Although a drop by half occurs twice in the first example, such a drop occurs only once in the fourth example. Similarly, in the second range RG2, as the first charging current ICH1 is output at a constant value, a large change in the second charging current ICH2 occurs only once and therefore a drop in the charging current IBAT occurs only once. Also, EN1=EN2=enable, DH[10:0]=127, and DL[10:0]=1024 may be implemented immediately after DIN[10:0] changes from 254 to 255. That is, in FIG. 10, the state of DH[10:0]=0 and DL[10:0]=2040 corresponding to the first 255 of DIN[10:0] may be absent.

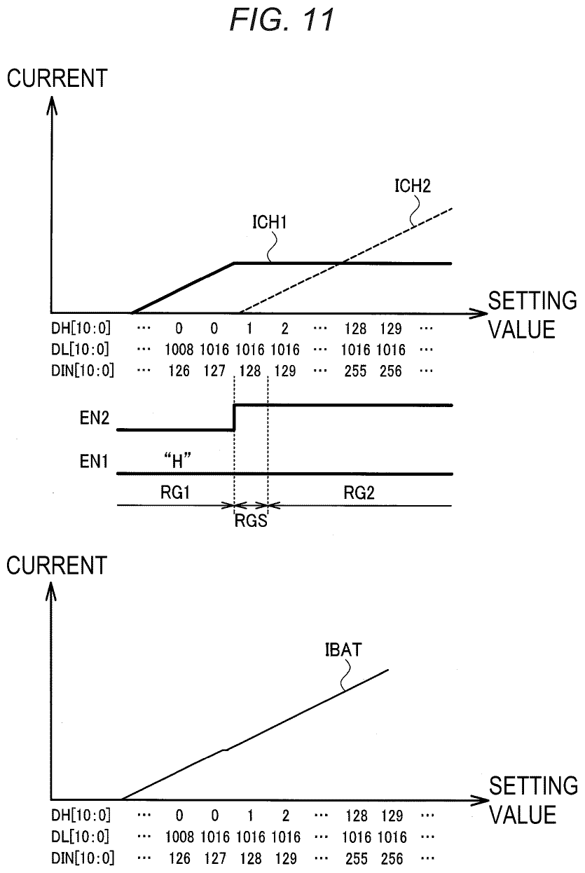

FIG. 11 shows a fifth example of the charging switching control according to the present embodiment. A range where the current setting value DIN[10:0] is equal to or greater than 0 and equal to or less than 127 is defined as the first range RG1, the one value of 128 is defined as the switching range RGS, and a range where the current setting value DIN[10:0] is equal to or greater than 129 and equal to or less than 2047 is defined as the second range RG2. The control in the first range RG1 is the same as in the first example.

Operations in the switching range RGS are as described below. When the current setting value DIN[10:0] is 128, the control circuit 160 outputs EN1=EN2=enable, DL[10:0]=8×127=1016, and DH[10:0]=DIN[10:0]−127. Similarly, in the second range RG2, the control circuit 160 outputs EN1=EN2=enable, DL[10:0]=8×127=1016, and DH[10:0]=DIN[10:0]−127. The value “127” is the maximum value of the current setting value DIN[10:0] in the first range RG1.

In the fifth example, in the switching range RGS and the second range RG2, the control circuit 160 maintains EN1=EN2=enable and DL[10:0]=8×127=1016, and outputs DH[10:0]=DIN[10:0]−127. Since the second charging current ICH2 equivalent to “−127” of DH[10:0] is compensated for by the first charging current ICH1 based on DL[10:0], the overall charging current IBAT has a current value corresponding to the current setting value DIN[10:0].

In the fifth example, since there is no significant change in the second charging current ICH2 in the switching range RGS, a drop in the charging current IBAT does not occur regardless of whether a delay occurs.

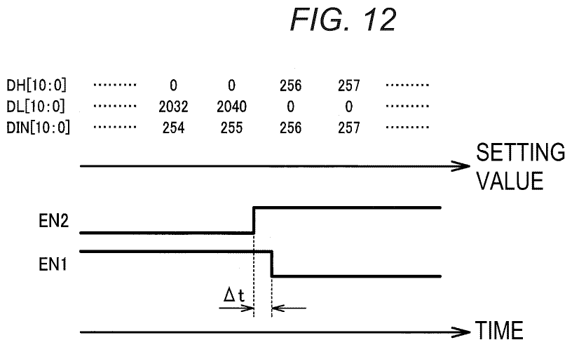

FIG. 12 shows a sixth example of the charging switching control according to the present embodiment. In this example, the same control as in FIGS. 5 and 6 is performed, but the switching timings of the first enable signal EN1 and the second enable signal EN2 are different.

Specifically, when the first current source control value DL[10:0] changes from 255 to 256, the control circuit 160 switches the second enable signal EN2 from the disable state to the enable state, and after the lapse of a predetermined time Δt, switches the first enable signal EN1 from the enable state to the disable state. Thus, since the first charging current ICH1 drops after the second charging current ICH2 starts to rise, the charging current IBAT does not become zero, and the drop in the charging current IBAT is reduced as compared with FIG. 6. The predetermined time Δt is set, for example, by circuit simulation so that the change in the charging current IBAT at the time of switching is small.

In the present embodiment, the circuit device 100 includes the current source circuit 140, the first charging circuit 110, the second charging circuit 120, and the control circuit 160. The first charging circuit 110 supplies the first charging current ICH1 of a constant current as the charging current IBAT to the charging node NBAT, based on the current from the current source circuit 140. The second charging circuit 120 supplies the second charging current ICH2 of a constant current as the charging current IBAT to the charging node NBAT, based on the current from the current source circuit 140. The control circuit 160 sets the current value of the first charging current ICH1 and the current value of the second charging current ICH2, based on the current setting value DIN[10:0] for setting the current value of the charging current IBAT. When the current setting value DIN[10:0] is in the first range RG1, the first charging circuit 110 supplies the first charging current ICH1 to the charging node NBAT. When the current setting value DIN[10:0] is in the second range RG2 on the higher current side than the first range RG1, the second charging circuit 120 supplies the second charging current ICH2 to the charging node NBAT. At the switching between the first range RG1 and the second range RG2, the first charging circuit 110 supplies the first charging current ICH1 to the charging node NBAT, and the second charging circuit 120 supplies the second charging current ICH2 to the charging node NBAT.

According to the present embodiment, since both the first charging current ICH1 and the second charging current ICH2 are supplied to the battery 10 at the switching between the first range RG1 and the second range RG2, even when one of the charging currents is not supplied due to a delay in the rise thereof, the other charging current is supplied. Thus, the charging current IBAT to the battery 10 does not drop to zero, and the likelihood of occurrence of charging failure can be reduced.

The “switching of the current setting value between the first range and the second range” corresponds to the switching range RGS shown in FIGS. 7 to 11, and more specifically, corresponds to when the first enable signal EN1 and the second enable signal EN2 are in the enable state, in the switching range RGS. In the second range RG2, at least the second charging circuit 120 supplies the second charging current ICH2 to the charging node NBAT, but the first charging circuit 110 may supply the first charging current ICH1 to the charging node NBAT as well. For example, in the second range RG2, in FIGS. 7 to 9, only the second charging circuit 120 performs charging, and in FIGS. 10 and 11, the first charging circuit 110 and the second charging circuit 120 perform charging.

In the present embodiment, at the switching, the first charging circuit 110 may supply the first charging current ICH1 lower than the current value indicated by the current setting value DIN[10:0] to the charging node NBAT. At the same time, the second charging circuit 120 may supply the second charging current ICH2 lower than the current value indicated by the current setting value DIN[10:0] to the charging node NBAT.

In the present embodiment, at the switching, the sum of the first charging current ICH1 and the second charging current ICH2 may be the current value indicated by the current setting value DIN[10:0].

According to the present embodiment, at the switching between the first range RG1 and the second range RG2, both the first charging current ICH1 and the second charging current ICH2 are supplied to the battery 10, and the sum of these charging currents is the current value indicated by the current setting value DIN[10:0]. Thus, even at the switching, an appropriate charging current IBAT corresponding to the current setting value DIN[10:0] is supplied to the battery 10.

As described with reference to FIGS. 7 to 9, at the switching of the current setting value DIN[10:0] from the first range RG1 to the second range RG2, the first charging circuit 110 may decrease the first charging current ICH1 in stages, and the second charging circuit 120 may increase the second charging current ICH2 in stages.

At the switching from the first range RG1 to the second range RG2, the rise of the second charging current ICH2 may be delayed, causing a drop in the charging current IBAT. According to the present embodiment, as the second charging current ICH2 is increased in stages, the amount of increase in one stage is smaller than when the second charging current ICH2 is made to rise at a time. Thus, the drop in the charging current IBAT can be reduced.

In the present embodiment, at the switching of the current setting value DIN[10:0] from the second range RG2 to the first range RG1, the first charging circuit 110 may increase the first charging current ICH1 in stages, and the second charging circuit 120 may decrease the second charging current ICH2 in stages.

At the switching from the second range RG2 to the first range RG1, the rise of the first charging current ICH1 may be delayed, causing a drop in the charging current IBAT. According to the present embodiment, as the first charging current ICH1 is increased in stages, the amount of increase in one stage is smaller than when the first charging current ICH1 is made to rise at a time. Thus, the drop in the charging current IBAT can be reduced.

Also, as described with reference to FIG. 9, at the switching of the current setting value DIN[10:0] from the first range RG1 to the second range RG2, when the second charging circuit 120 increases the second charging current ICH2 in stages, the amount of increase from the second stage onward may be smaller than the amount of increase in the first stage.

For example, as shown in FIG. 7, when the second charging circuit 120 increases the second charging current ICH2 in two stages by half each, a drop by about half occurs in the charging current IBAT twice. According to the present embodiment, the drop in the charging current IBAT after the second time is dispersed to relatively small drops. Thus, a relatively large drop can be limited to once.

Also, as described with reference to FIGS. 7 to 9, in the first range RG1, the control circuit 160 may set the first charging circuit 110 in the enable state and may set the second charging circuit 120 in the disable state. In the second range RG2, the control circuit 160 may set the first charging circuit 110 in the disable state and may set the second charging circuit 120 in the enable state. At the switching, the control circuit 160 may set the first charging circuit 110 and the second charging circuit 120 in the enable state.

According to the present embodiment, in the first range RG1, only the first charging circuit 110 supplies the charging current IBAT, and in the second range RG2, only the second charging circuit 120 supplies the charging current IBAT. At the switching, the first charging circuit 110 and the second charging circuit 120 supply the charging current IBAT, and the drop in the charging current IBAT can thus be reduced as described above.

As described with reference to FIGS. 10 and 11, in the second range RG2, the first charging circuit 110 may supply a constant first charging current ICH1 having the same current value as the first charging current ICH1 at the switching, to the charging node NBAT.

In the second range RG2, the sum of the first charging current ICH1 and the second charging current ICH2 may be the current value indicated by the current setting value DIN[10:0].

Also, in the first range RG1, the control circuit 160 may set the first charging circuit 110 in the enable state and may set the second charging circuit 120 in the disable state. In the second range RG2 and at the switching, the control circuit 160 may set the first charging circuit 110 and the second charging circuit 120 in the enable state.

For example, as shown in FIG. 7, if the first charging current ICH1 is decreased when the current setting value enters the second range RG2, the second charging current ICH2 needs to be increased accordingly and a drop in the charging current IBAT occurs. According to the present embodiment, when the current setting value enters the second range RG2, the first charging current ICH1 is kept constant and therefore the second charging current ICH2 need not be increased accordingly. Thus, the number of times the charging current IBAT drops can be reduced. For example, in FIG. 10, a drop occurs once, and in FIG. 11, a drop occurs 0 times.

In the present embodiment, the current source circuit 140 may include the first current source circuit 141 that supplies the first current IS1 to the first charging circuit 110, and the second current source circuit 142 that supplies the second current IS2 to the second charging circuit 120. The first charging circuit 110 may amplify the first current IS1 with the first amplification ratio and thus may supply the first charging current ICH1 to the charging node NBAT. The second charging circuit 120 may amplify the second current with the second amplification ratio higher than the first amplification ratio and thus may supply the second charging current ICH2 to the charging node NBAT.

According to the present embodiment, since the first current source circuit 141 and the second current source circuit 142 are provided, both the first charging circuit 110 and the second charging circuit 120 can output the charging current at the switching. Also, since the first current source circuit 141 and the first charging circuit 110 for low charging and the second current source circuit 142 and the second charging circuit 120 for high charging are separately provided, an optimal circuit can be configured for each of low charging and high charging. For example, when charging that ranges from low charging to high charging is implemented by a common charging circuit, the current source circuit needs to generate currents ranging from a very small current to a large current. In this case, it is difficult to design the current source circuit due to the limit of the minimum size of the transistor or the like. Alternatively, since one step of the current output from the current source circuit is very small, the amplification of the current to form the charging current is likely to be affected by an offset or the like of the amplifier circuit and therefore the current may not be able to be amplified accurately. According to the present embodiment, since low charging and high charging are separated, the range of the current generated by the current source circuit can be narrowed. Also, since one step of the current output from the current source circuit can be increased, the current can be accurately amplified in the amplification of the current to form the charging current.

While the embodiment has been described in detail above, those skilled in the art can readily understand that many modifications can be made without substantially departing from the novel matters and the effects of the present disclosure. Therefore, all such modifications are included in the scope of the present disclosure. For example, a term described at least once together with a different term having a broader meaning or the same meaning in the specification or the drawings can be replaced with the different term at any point in the specification or the drawings. All combinations of the embodiment and the modifications are also included in the scope of the present disclosure. The configurations and operations of the current source circuit, the first charging circuit, the second charging circuit, the control circuit, the reference voltage generation circuit, the circuit device, and the electronic device are not limited to those described in the present embodiment, and various modifications can be made.

What is claimed is:

1. A circuit device comprising:
a current source circuit;
a first charging circuit that supplies a first charging current of a constant current as a charging current to a charging node, based on a current from the current source circuit;
a second charging circuit that supplies a second charging current of a constant current as the charging current to the charging node, based on a current from the current source circuit; and
a control circuit that sets a current value of the first charging current and a current value of the second charging current, based on a current setting value for setting a current value of the charging current, wherein
the first charging circuit supplies the first charging current to the charging node when the current setting value is in a first range,
the second charging circuit supplies the second charging current to the charging node when the current setting value is in a second range on a higher current side than the first range, and
the first charging circuit supplies the first charging current to the charging node and the second charging circuit supplying the second charging current to the charging node, at a switching of the current setting value between the first range and the second range.

2. The circuit device according to claim 1, wherein
at the switching, the first charging circuit supplies the first charging current lower than the current value indicated by the current setting value to the charging node, and the second charging circuit supplies the second charging current lower than a current value indicated by the current setting value to the charging node.

3. The circuit device according to claim 2, wherein
at the switching, a sum of the first charging current and the second charging current is the current value indicated by the current setting value.

4. The circuit device according to claim 1, wherein
at the switching of the current setting value from the first range to the second range, the first charging circuit decreases the first charging current in stages, and the second charging circuit increases the second charging current in stages.

5. The circuit device according to claim 1, wherein
at the switching of the current setting value from the second range to the first range, the first charging circuit increases the first charging current in stages, and the second charging circuit decreases the second charging current in stages.

6. The circuit device according to claim 4, wherein
when the second charging circuit increases the second charging current in stages at the switching of the current setting value from the first range to the second range, an amount of increase from a second stage onward is smaller than an amount of increase in a first stage.

7. The circuit device according to claim 4, wherein
the control circuit
sets the first charging circuit in an enable state and sets the second charging circuit in a disable state, in the first range,
sets the first charging circuit in the disable state and sets the second charging circuit in the enable state, in the second range, and
sets the first charging circuit and the second charging circuit in the enable state, at the switching.

8. The circuit device according to claim 1, wherein
in the second range, the first charging circuit supplies the first charging current that is constant, having a same current value as the first charging current at the switching, to the charging node.

9. The circuit device according to claim 8, wherein
in the second range, a sum of the first charging current and the second charging current is a current value indicated by the current setting value.

10. The circuit device according to claim 8, wherein
the control circuit
sets the first charging circuit in an enable state and sets the second charging circuit in a disable state, in the first range, and
sets the first charging circuit and the second charging circuit in the enable state, in the second range and at the switching.

11. The circuit device according to claim 1, wherein
the current source circuit includes:
a first current source circuit that supplies a first current to the first charging circuit; and
a second current source circuit that supplies a second current to the second charging circuit,
the first charging circuit amplifies the first current with a first amplification ratio and thus supplies the first charging current to the charging node, and
the second charging circuit amplifies the second current with a second amplification ratio higher than the first amplification ratio and thus supplies the second charging current to the charging node.

12. An electronic device comprising:
the circuit device according to claim 1; and
a battery coupled to the charging node.
